(19) United States
(12) Patent Application Publication
(10) Pub. No.: US 2019/0017899 A1
(43) Pub. Date: Jan. 17, 2019

(54) METHOD AND MEASURING ASSEMBLY FOR DETECTING SLIP IN ROLLING BEARINGS

(71) Applicant: SCHAEFFLER TECHNOLOGIES AG & CO. KG, Herzogenaurach (DE)

(72) Inventors: Joerg LOOS, Herzogenaurach (DE); Iris BERGMANN, Erlangen (DE); Joachim HERING, Wuerzburg (DE)

(73) Assignee: SCHAEFFLER TECHNOLOGIES AG & CO. KG, Herzogenaurach (DE)

(21) Appl. No.: 16/069,011

(22) PCT Filed: Oct. 17, 2016
(86) PCT No.: PCT/DE2016/200473

§ 371 Date: Jul. 10, 2018

(30) Foreign Application Priority Data
Jan. 21, 2016 (DE) 10 2016 200 837.4

(51) Int. Cl. G01M 13/04; F16C 19/26; F16C 19/52

(52) U.S. Cl. CPC G01M 13/04; F16C 2233/00; F16C 19/52; F16C 19/26

(57) ABSTRACT

A method, comprising recording the number of rotations of a first bearing race in relation to a second bearing race in a roller bearing, recording counts of at least one indicator, wherein at least one indicator indicates a revolutions of a plurality of rolling elements about the second bearing race, calculating a ratio between the recorded counts of the at least one indicator with a recorded number of revolutions of the first bearing race, comparing the calculated ratios with a corresponding ideal value for the ratio, wherein the corresponding ideal value is determined without friction fit-induced slip, determining a difference in the comparison, and outputting the difference as an average friction fit-induced slip for the plurality of rolling elements.

### CROSS-REFERENCE TO RELATED APPLICATIONS

This application is the U.S. National Phase of PCT/DE2016/200473 filed Oct. 17, 2016, which claims priority to DE 102016200837.4 filed Jan. 21, 2016, the entire disclosures of which are incorporated by reference herein.

### TECHNICAL FIELD

The present disclosure relates to monitoring rolling bearings. In particular, the disclosure relates to a method for detecting the average friction fit-induced slip of a plurality of rolling elements in a rolling bearing. The disclosure also relates to a measuring assembly for determining the average friction fit-induced slip of a plurality of rolling elements in a rolling bearing.

### BACKGROUND

By monitoring rolling bearings, the lubrication, e.g. oil flow, amount, or type of lubrication can be improved. This may already be useful when developing machines, as well as giving an indication of the load when in use.

Rolling bearings are frequently monitored by measuring accelerations and temperature. With these methods, damage is usually detected when the measurements reach a specific threshold value. It is difficult to derive any indication, however, regarding what may have caused the damage.

Monitoring bearing preload is another method that can provide indications of problems, e.g. rolling bearing lubrication. Bearing preloads depend heavily on the bearing temperature, as well as the ambient temperature, and react slowly.

Another method comprises monitoring the bearing load, which is complex and expensive, and therefore is only economically worthwhile in special cases.

Detection of slip in the bearing, between bearing races and the rolling elements, is of great interest regarding the reliable operation of a rolling bearing without damage thereto. With bearing slip, the rolling elements do not roll as desired on the raceways in the races, such that the rotational rate of the rolling elements does not deviate from the rotational rate of the rotating bearing race, when the other bearing race is non-rotatable, to the extent prescribed by the geometric relationship between the bearing races and the rolling elements.

Thus a first extreme case is conceivable in which the rolling element rotational rate defined above is identical to the rotational rate of the rotating bearing race, such that the rolling elements slide over the raceway of the stationary bearing race. In a second extreme case, the rolling element rotational rate is identical to the rotational rate of the stationary bearing race, thus zero, wherein the rolling elements slide over the raceway in the rotating bearing race.

A known method for determining the slip is the comparison of measuring signals from two rotational rate sensors, which record the rotational rate of a rotating inner bearing race and the rotational rate of the rolling elements. If these rotational rates do not have the rotational rate ratio to one another that is expected, it can be assumed that there is slip between the two specified bearing components.

The slip can also be determined with a first sensor that measures the temporal angular change in the rotational rate of the rotating inner bearing race and this is compared with the frequency with which rolling elements in the bearing roll past the attachment location of a second sensor, e.g. a strain gauge, on the outer bearing race or the inner bearing race.

A method for determining the slip between a rotating bearing race and the rolling elements located between the bearing races is known from DE 103 14 295 B4, in which the rotational rates of these bearing components about the rotational center of the bearing are determined and compared with one another. By using a single SAW or BAW sensor with a transmitting antenna, the passing frequency can be determined from the passing of the rolling elements over the sensor, and the angular change in the rotational position can be determined by the transmitting antenna. The rotational rate of the rolling elements can be calculated from the passing frequency, and the rotational rate of the rotating bearing race can be calculated from the change in the rotational angle. By comparing the two rotational rates, a ratio is obtained between the current rotational rates, which can be compared with the expected rotational rate ratio. If the expected rotational rate ratio is not reached or is exceeded, this is an indication of slippage between the bearing components.

A direct measurement of passing frequencies or rotational rates of rolling elements, the bearing cage, or bearing races can only provide useful information regarding lubrication when there is a high level of slippage with very lightly loaded rolling bearings, thus loaded below the minimum load

### SUMMARY

The object of the disclosure is to provide a method and a measuring assembly that enable an improved slip detection, and enable precise evaluation and monitoring of the lubrication state in rolling bearings.

This problem is solved according to the disclosure by a detection method and a measuring assembly for determining the average friction fit-induced slip of a plurality of rolling elements in a rolling bearing. The rolling bearing further comprises a first bearing race and a second bearing race, wherein the first bearing race and the second bearing race can rotate in relation to one another. Alternatively, the rolling bearing can also comprise a rolling bearing cage.

The method according to the disclosure comprises steps for recording the number of rotations of the first bearing race in relation to the second bearing race, recording the counts of at least one indicator, wherein the at least one indicator indicates the revolutions of the plurality of rolling elements and the second bearing race.

The method also comprises either calculation of the relationship between the recorded counts of the at least one indicator with the recorded number of revolutions of the first bearing race, and comparison of the calculated ratios with a corresponding ideal value for the ratio, wherein this ideal value is determined without friction fit-induced slip; or alternatively, determination of an ideal value for the at least one indicator for the recorded number or revolutions of the first bearing race, wherein the ideal value is determined without friction fit-induced slip, and comparison of the determined ideal value with the recorded counts of the at least one indicator.

The method also comprises a determination of the difference in the comparison, and outputting the difference as the average friction fit-induced slip for the plurality of rolling elements.

The ideal ratio value, or the ideal value, respectively, is determined by the outer diameter of the inner bearing race, the inner diameter of the outer bearing race, and the diameter of the rolling elements.

The ideal ratio value is not time-dependent when there is no bearing slip. Thus, the plurality of rolling elements, i.e. the aforementioned at least one indicator, pass over a counter point fifteen times, by way of example, in one revolution of the first bearing race in a predefined bearing geometry. In order to obtain a high level of precision with the method, measurements must be taken over the course of a longer time period. Thus, 4,000 revolutions of the first bearing race can be counted, requiring less than 20 seconds with quickly rotating bearings. The expected counts of the at least one indicator is 60,000 in this example, and the ideal ratio value is 15. The counts actually recorded for the indicator may, however, be lower, e.g. 59,860, due to slippage. This results in an actual ratio of 59,860/4,000=14.965. The average friction fit-induced slip is thus 15/14.965−thus ca. 0.234%. Assuming an imprecision of ±1 for the recording of the counts of the indicator, to accommodate for whole numbers, this results in a deviation of just:

15/(59,861/4,000)=ca. 0.232%, or 15/(59,859/4,000)=ca. 0.236%, thus ±0.002%

The ideal ratio value in the preceding example is the expected count for the at least one indicator in one revolution. In a second alternative, an ideal value can also be dependent on a predefined number of revolutions, thus, e.g., the determination of the counts of the at least one indicator for a given 4,000 revolutions of the first bearing race. In this case, the counts of the indicator, i.e. 60,000 can be placed in relation to the detected counts of the indicator, e.g. 59,860:60,000/59,860−ca. 0.234%. The advantage with this alternative is that the determination of an ideal value does not necessarily require multiplication, e.g. 15×4,000=60,000. Instead, it is possible to store a pre-calculated list of ideal values in a memory in a data processing unit, e.g. ideal values for numerous samples of 4,000 revolutions. These ideal values can be output via a less processing-intensive computing operation. In the preceding first alternative, a division operation must always be carried out in calculating the actual ratio, wherein the ideal ratio value is always the same, and is output from the memory when the two values are compared.

The concept may be the same in both alternatives: specifically, absolute values are recorded over a longer period of time, and no time-specific rotational rates or passing frequencies are determined. In this manner, an average friction fit-induced slip of less than 1% can be determined with the method according to the disclosure, which could only be achieved with the previously known methods in a few special cases.

In one embodiment, the at least one indicator is the plurality of rolling elements. Thus, the rolling elements of the rolling bearing are used directly as indicator(s). In a further embodiment, the plurality of rolling elements are recorded with a sensor. Such a sensor can be a strain gauge, for example, over which the rolling elements roll.

In another embodiment, the at least one indicator is a mark on a rolling bearing cage in the rolling bearing. In a further embodiment, numerous marks are place over the circumference of the cage. A uniform distribution of the marks on the cage is useful, which is similar to the geometrically uniform distribution of the rolling elements in a rolling bearing cage. Numerous marks are also advantageous because this increases the precision of the measurements. Furthermore, a mark can also be detected with an optical sensor, which is not incorporated in the rolling bearing, but instead is merely aimed at the rolling bearing, thus offering a simple technological solution for checking the slip in existing rolling bearings. Alternatively or additionally, the mark or numerous marks can be applied to the plurality of rolling elements.

In one embodiment, the first bearing race comprises a further mark. The further mark is detected by a further sensor. This can ideally be an optical sensor, or it may be a laser sensor.

The optical sensor for detecting the further mark on the first bearing race and the optical sensor for detecting the aforementioned marks on the bearing cage and/or the plurality of rolling elements can be integrated in a structural unit. In this manner, an autonomous and closed measuring assembly can be created, which can be used for numerous examinations of rolling bearings for slip. A bearing therefore does not need to be equipped with a complex sensor system, but instead only requires marks to be placed at the appropriate locations on the bearing.

In one embodiment, the method also comprises steps in which the recorded number of revolutions of the first bearing race is multiplied with the circumference of the raceway in the first bearing race and the friction fit-induced slip, and the result is output as a frictional distance for the plurality of rolling elements in the rolling bearing. In continuing the counting example described above, and assuming a circumference of the raceway of 20 cm, the frictional distance is 20 cm×0.234%=ca. 0.0468 cm. The frictional distance can also be referred to as the slip distance.

In one embodiment, the first bearing race is a rotating bearing race, and the second bearing race is a stationary bearing race.

The person skilled in the art can use the method according to the disclosure in order to draw conclusions regarding different situations. As a result of the very precise determination of the slip to within 1%, it is possible to draw timely conclusions for the following non-comprehensive examples:

lubrication state: in general, slip, or friction, increases as the lubrication ages;

pv-value (product of pressure p and sliding speed v): as the slip increases, the pv-value also increases, indicating a tendency to white etching crack (WEC) defects and wear;

critical dynamics resulting from, e.g., increased resonance in the bearing: the slip increases due to dynamics or inertial forces;

pre-tensioning or loss of an intended pre-tensioning: the slip decreases or increases abruptly;

cage tensioning resulting from drives for rib contact: slip is negative, and decreases;

bearing load and service life: slip is a function of the load when the bearing friction is known.

The disclosure furthermore comprises a measuring assembly for determining the average friction fit-induced slip of a plurality of rolling elements in a rolling bearing, with which the method for determining the average friction fit-induced slip can be used.

A further aspect of the present disclosure is a computer program product, which executes computer-implemented steps of the method when it is downloaded to a memory in a data processing unit, and executed by at lest one processor in the data processing unit.

Further advantages, features and details of the disclosure can be derived from the following description of exemplary embodiments, and from the drawings.

### BRIEF DESCRIPTION OF THE DRAWINGS

An exemplary embodiment of the disclosure shall be described below, based on the figures. Therein:

FIG. 1 shows the measuring assembly according to the disclosure, while in use;

FIG. 2 shows a flow chart illustrating the method according to the disclosure.

The figures are not drawn to scale. The respective sizes of the pictograms are to be understood symbolically, and are not coordinated to one another.

### DETAILED DESCRIPTION

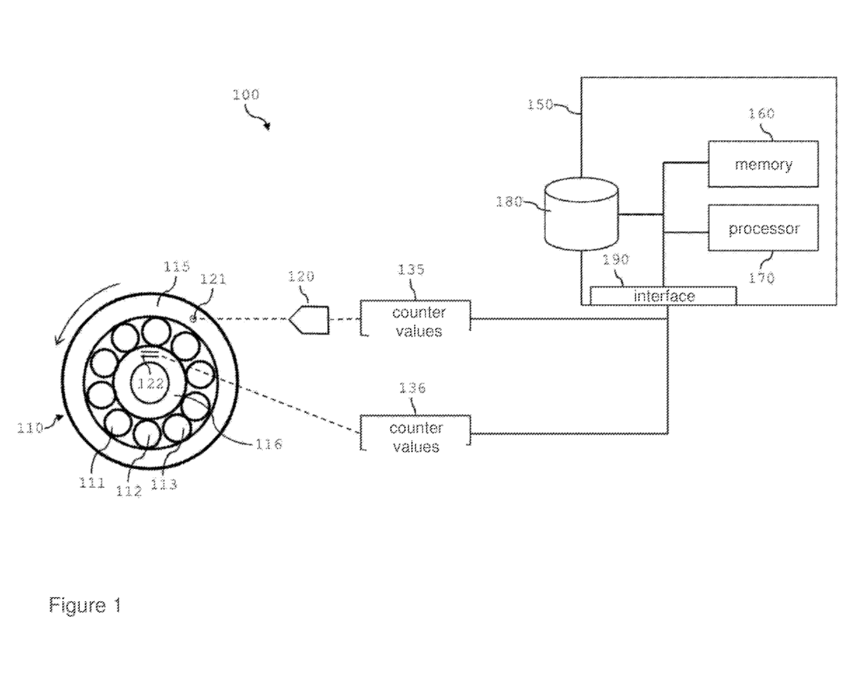

FIG. 1 shows the measuring assembly 100 according to the disclosure, for determining the average friction fit-induced slip of a plurality of rolling elements 111, 112, 113 in a rolling bearing 110 when in use, wherein the data processing unit 150 is depicted as a block diagram.

The rolling bearing 110 also comprises a first baring race 115, a second bearing race 116, and a cage (not shown). The cage (not shown) receives the plurality of rolling elements 111, 112, 113 between the first and second bearing races. The first bearing race 115 and the second bearing race 116 can rotate in relation to one another. The measuring assembly 100 comprises a first sensor 120 configured to record the number of revolutions of the first bearing race 115 in relation to the second bearing race 116. This results in counter values 135. In one embodiment, the first bearing race 115 is a rotating bearing race and the second bearing race 116 is a stationary bearing race. The measuring assembly 100 also comprises a second sensor 122 configured for recording the counts of at least one indicator, wherein the at least one indicator indicates the revolutions of the plurality of rolling elements 111, 112, 113 about the second bearing race 116. This results in counter values 136.

In one embodiment, the first sensor 120 is an optical sensor. In particular a laser sensor is suitable for this, for detecting a mark 121 on the first bearing race 115. The second sensor 122 is illustrated as a strain gauge in FIG. 1, for recording the passage of the plurality of rolling elements 111, 112, 113 over the strain gauge. Alternatively, it is also conceivable to apply at least one further mark to the bearing cage (not shown), and to likewise detect this mark with one or the same optical sensor.

The measuring assembly 100 also comprises the data processing unit 150 with at least one data storage component 160, at least one processor 170, and at least one interface 190. By way of example, the interface 190 is capable of bidirectional data exchange. It can also communicate with acoustic or graphical output devices. The interface 190 can thus receive counter values 135 and 136 in the form of data input. The data processing unit 150 is configured for two different data processings based on the counter values 135 and 136.

The measuring assembly 100 also comprises the data processing unit 150 with at least one data storage component 160, at least one processor 170, and at least one interface 190. By way of example, the interface 190 is capable of bidirectional data exchange. It can also communicate with acoustic or graphical output devices. The interface 190 can thus receive counter values 135 and 136 in the form of data input. The data processing unit 150 is configured for two different data processings based on the counter values 135 and 136.

The calculation of the ratio between the recorded counts of the at least one indicator, thus counter value 136, is therefore carried out with the recorded number of revolutions of the first bearing race, thus counter value 135, in a first configuration, and the calculated ratio is subsequently compared with a corresponding ideal ratio value. The ideal ratio value is determined without friction fit-induced slip.

In an alternative second configuration, the determination of an ideal value for the at least one indicator, thus counter value 136, is carried out for the recorded number of revolutions of the first bearing race, thus counter value 135. The ideal value is defined without friction fit-induced slip. The ideal value can be output for various numbers of revolutions from list in the data base 180. The data base 180 can be part of the data processing unit 150, but it can also be accessed from another memory, e.g. via internet. For this reason, the data base 180 in FIG. 1 is depicted on the system boundaries of the data processing unit 150. Furthermore, the determined ideal value is compared with the recorded counts of the at least one indicator in the second configuration.

The comparisons in the first and second configurations are then used to determine the difference. The difference is the same in both configurations. The difference is subsequently output as the average friction fit-induced slip of the plurality of rolling elements in the rolling bearing 10.

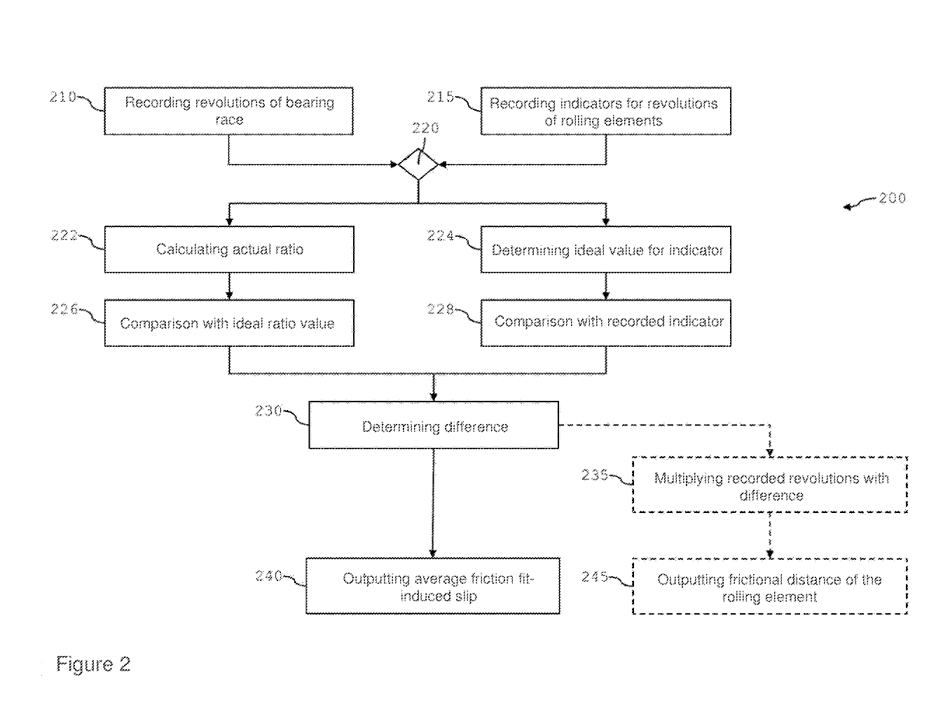

FIG. 2 shows a flow chart illustrating the method 200 according to the disclosure for determining the average friction fit-induced slip of a plurality of rolling elements in a rolling bearing. The rolling bearing comprises a plurality of rolling elements in a rolling bearing. The rolling bearing also comprises a first bearing race and a second bearing race. The first and second bearing races can rotate in relation to one another. The method comprises recording 210 the number of revolutions of the first bearing race in relation to the second bearing race, recording 215 the counts of the at least one indicator, wherein the at least one indicator indicates the revolutions of the plurality of rolling elements about the second bearing race.

The method 200 can continue in a first alternative 200 with the calculation 222 of the ratio between the recorded counts of the at least one indicator and the recorded number of revolutions of the first bearing race, and a comparison 226 of the calculated ratio with a corresponding ideal ratio value, wherein the ideal ratio value is determined without friction fit-induced slip.

The method 200 can continue in a second alternative 220 with the determination 224 of an ideal value of the at least one indicator for the recorded number of revolutions of the first bearing race, wherein the ideal value is determined without friction fit-induced slip, and with a comparison 228 of the determined ideal value with the recorded count of the at least one indicator.

After the comparison in the first or second alternatives, the method 200 comprises a determination 230 of the difference in the comparison 226, 228, and outputting 240 the difference as the average friction fit-induced slip for the plurality of rolling elements in the rolling bearing.

Optionally, the so-called frictional distance of the plurality of rolling elements can also be determined. This optional determination is depicted in FIG. 2 by the broken lines. The method 200 also comprises the multiplication 235 of the recorded number of revolutions of the first bearing race 115 with the circumference of the raceway on the first bearing race and the friction fit-induced slip, and the subsequent outputting 245 of the result as a frictional distance for the plurality of rolling elements in the rolling bearing.

1. A method for determining an average friction fit-induced slip of a plurality of rolling elements in a rolling bearing, wherein the rolling bearing also comprises a first bearing race and a second bearing race, wherein the first and second bearing races can rotate in relation to one another, in which the method comprises the following steps:
recording the number of revolutions of the first bearing race in relation to the second bearing race,
recording the counts of tat least one indicator, wherein the at least one indicator indicates the revolutions of the plurality of rolling elements about the second bearing race,
determining of an ideal value of the at least one indicator for the recorded number of revolutions of the first bearing race, wherein the ideal value is determined without friction fit-induced slip, or
comparing the determined ideal value with the recorded counts of the at least one indicator,
determining a difference in the comparing, and
outputting the difference as the average friction fit-induced slip of the plurality of rolling elements.

2. The method of claim 1, wherein the at least one indicator is the plurality of rolling elements.

3. The method of claim 2, wherein the plurality of rolling elements is recorded with a strain gauge.

4. The method of claim 1, wherein the at least one indicator is a mark on a bearing cage of the rolling bearing.

5. The method of claim 4, wherein the marks are distributed over a circumference of the cage.

6. The method of claim 5, wherein the first bearing race includes a further mark, and wherein the further mark is detected with a further sensor, in particular an optical sensor, preferably a laser sensor.

7. The method of claim 6, wherein the method further comprises the following steps:
multiplying the recorded number of revolutions of the first bearing race with a raceway circumference of the first bearing race, and the friction fit-induced slip, and
outputting the multiplication as a frictional distance of the plurality of rolling elements in the rolling bearing.

8. The method according of claim 7, wherein the first bearing race is a rotating bearing race, and the second bearing race is a stationary bearing race.

9. A measuring assembly configured to determine an average friction fit-induced slip of a plurality of rolling elements in a rolling bearing, wherein the rolling bearing also includes a first bearing race and a second bearing race, wherein the first bearing race and the second bearing race can rotate in relation to one another, in which the measuring assembly comprises:
a first sensor configured to record a number of revolutions of the first bearing race in relation to the second bearing race;
a second sensor configured for recording the counts of at least one indicator, wherein the at least one indicator indicates revolutions of the plurality of rolling elements about the second bearing race;
at least one data processing unit that has at least one data storage component;
at least one processor; and
at least one interface configured to:
calculate a ratio of the recorded counts of the at least one indicator to the recorded number of revolutions of the first bearing race, and
compare the calculated ratio with a corresponding ideal ratio value, wherein the ideal ratio value is determined without friction fit-induced slip,
determine an ideal value of the at least one indicator for the recorded number of revolutions of the first bearing race, wherein the ideal value is determined without friction fit-induced slip,
compare the determined ideal value with the recorded counts of the at least one indicator,
determine a difference in the comparison, and
output the difference as the average friction fit-induced slip of the plurality of rolling elements.

10. The measuring assembly of claim 9, wherein the first sensor is an optical sensor configured to detect a mark on the first bearing race.

11. The measuring assembly of claim 9, wherein the second sensor is a strain gauge configured to record a passage of the plurality of rolling elements over the strain gauge.

12. A method, comprising:
recording the number of rotations of a first bearing race in relation to a second bearing race in a roller bearing;
recording counts of at least one indicator, wherein at least one indicator indicates a revolutions of a plurality of rolling elements about the second bearing race;
calculating a ratio between the recorded counts of the at least one indicator with a recorded number of revolutions of the first bearing race;
comparing the calculated ratios with a corresponding ideal value for the ratio, wherein the corresponding ideal value is determined without friction fit-induced slip;
determining a difference in the comparison; and
outputting the difference as an average friction fit-induced slip for the plurality of rolling elements.

13. The method of claim 12, wherein the method further includes the steps of:
determining an ideal value for at least one indicator for the recorded number of revolutions of the first bearing race, wherein the ideal value is determined without friction fit-induced slip, and
comparing the determined ideal value with the recorded counts of the at least one indicator.

14. The method of claim 12, wherein the method further includes the steps of:
determining an ideal value for the at least one indicator for the revolutions of the first bearing race, wherein the ideal value is determined without friction fit-induced slip, and
comparing the determined ideal value with the recorded counts of the at least one indicator.
